(19) United States
(12) Patent Application Publication
(10) Pub. No.: US 2025/0271733 A1
(43) Pub. Date: Aug. 28, 2025

(54) OPTICAL APPARATUS

(71) Applicant: CANON KABUSHIKI KAISHA, Tokyo (JP)

(72) Inventor: MASAYASU SHIGEMATSU, Tokyo (JP)

(21) Appl. No.: 19/061,205

(22) Filed: Feb. 24, 2025

(30) Foreign Application Priority Data
Feb. 26, 2024 (JP) 2024-026140

(51) Int. Cl. G03B 17/08; G02B 1/04; G02B 7/02; G02B 23/00; G03B 17/12

(52) U.S. Cl. CPC G03B 17/08; G02B 1/041; G02B 7/021; G02B 7/025; G02B 7/028; G02B 23/145; G03B 17/12

(57) ABSTRACT

An optical apparatus includes a first optical member and a first holding member configured to hold the first optical member and a second optical member located on an inner side of the first optical member that are sealed with a first sealing member A space between the first optical member and the second optical member is sealed.

### BACKGROUND

### Technical Field

The present disclosure relates to a sealing structure of an optical apparatus having a plurality of optical members arrayed in an optical axis direction. For example, the present disclosure relates to a sealing structure of an optical apparatus which constitutes a finder unit of a camera main body.

### Description of the Related Art

Conventionally, a difference has occurred in the ambient temperature and a temperature of an inner side of a camera when the camera is suddenly relocated to a cold environment such as an environment of winter, a cold weather, or a night time, from a warm environment such as a room temperature environment.

Because a temperature is lowered on the inner side of an eyepiece lens which is in contact with the ambient air, a saturated moisture amount of moisture inside the camera is decreased. As a result, dew condensation may occur on a surface on the inner side of the eyepiece lens which is in contact with the ambient air.

Further, there is a case where the camera is turned on under a high-humidity and low-temperature environment such as an environment of a rainy weather.

When the camera is turned on, a temperature of an inner side of the camera is increased due to heat generated from an integrated circuit mounted on an electronic substrate or heat generated from a backlight used for a display element included in a viewfinder. Accordingly, dew condensation may similarly occur on the surface on the inner side of the eyepiece lens which is in contact with the ambient air.

In any of the above-described cases, there is a disadvantage that visibility is degraded by dew condensation because the user cannot wipe the inner side of the eyepiece lens.

With respect to the above-described disadvantage, dew condensation can be reduced by a structure which prevents entry of moisture into the inner side of the eyepiece lens in contact with the ambient air.

Japanese Patent Application Laid-Open No. 2021-135354 discusses a method which suppresses entry of moisture into the inner side of the eyepiece lens in contact with the ambient air, by sealing a space between an outermost lens and a second-outermost lens by annularly bonding the outermost lens and the second-outermost lens with an adhesive medium.

### SUMMARY

An aspect of the present disclosure is to provide a holding structure of optical members, capable of reducing worsening of surface accuracy, degradation of resolution, and distortion of an image, even when either an eyepiece lens in contact with the ambient air or a second-outermost eyepiece lens is made of a plastic material.

Another aspect of the present disclosure is to provide a holding structure of optical members, capable of suppressing dew condensation caused by entry of moisture into the inner side of the eyepiece lens.

According to an aspect of the present disclosure, an optical apparatus includes a first optical member and a second optical member located on an inner side of the first optical member from among an optical system including at least two optical members, a first holding member configured to hold the first optical member and the second optical member, a first sealing member configured to seal a gap between the first optical member and the first holding member, and a second sealing member configured to seal a gap between the first holding member and the second optical member, wherein the second optical member has an abutting portion on an outer circumferential portion, at which the second sealing member is in close contact with the second optical member, wherein the first holding member has an abutting portion on an outer circumferential portion, at which the second sealing member is in close contact with the first holding member, wherein the first optical member and the first holding member are sealed with the first sealing member, and wherein a space between the first optical member and the second optical member is sealed.

Further features of the present disclosure will become apparent from the following description of exemplary embodiments with reference to the attached drawings.

### BRIEF DESCRIPTION OF THE DRAWINGS

FIGS. 1A and 1B are external perspective views of a digital camera.

FIG. 2 is a cross-sectional view of an eyepiece unit.

FIG. 3 is an exploded perspective view of the eyepiece unit.

FIG. 4 is an exploded perspective view illustrating a state before an optical member is mounted on a lens holding member.

FIG. 5 is an exploded perspective view illustrating a state before a spacer is mounted on the lens holding member.

FIG. 6 is an exploded perspective view illustrating a state before an optical member is mounted on the lens holding member.

FIG. 7 is an exploded perspective view illustrating a state before a spacer is mounted on the lens holding member.

FIG. 8 is an exploded perspective view illustrating a state before an elastic member is mounted on the lens holding member.

FIG. 9 is an exploded perspective view illustrating a state before an optical member is fixed to a lens holding member with a sealing member.

FIG. 10 is an exploded perspective view illustrating a state before an optical member is mounted on the lens holding member.

FIG. 11 is an exploded perspective view illustrating a state before a gap between the lens holding member and the optical member is sealed with a sealing member.

FIG. 12 is an exploded perspective view illustrating a state before the lens holding members are combined.

### DESCRIPTION OF THE EMBODIMENTS

By the conventional technique discussed in Japanese Patent Application Laid-Open No. 2021-135354, entire circumferences of lenses can be bonded when an eyepiece lens in contact with the ambient air and a second-outermost lens are made of glass because the lenses are not affected by shrinkage of an adhesive agent that occurs when the adhesive agent is hardened.

However, it is often the case that a plastic material is used for an eyepiece lens in order to reduce cost and a weight.

In a case where the entire circumferences of the lenses are bonded to each other when a plastic material is used for an eyepiece lens, the lens is deformed by shrinkage of an adhesive agent that occurs when the adhesive agent is hardened, so that surface accuracy of the lens surface is worsened. This causes degradation of resolution and distortion of an image.

Therefore, when a lens made of a plastic material is to be bonded to another lens, it is often the case that the lenses are partially bonded to each other instead of being bonded in the entire circumferences, in order to prevent worsening of surface accuracy caused by deformation of the lens.

In other words, the entire circumferences of the lenses cannot be adhered to each other in a case where at least either one of the eyepiece lens in contact with the ambient air and the second-outermost lens is made of plastic materials.

Therefore, it is not possible to prevent entry of moisture into the inner side of the eyepiece lens by the conventional technique discussed in Japanese Patent Application Laid-Open No. 2021-135354.

Hereinafter, exemplary embodiments of the present disclosure will be described in detail with reference to the appended drawings.

### (External Perspective View of Digital Camera 100)

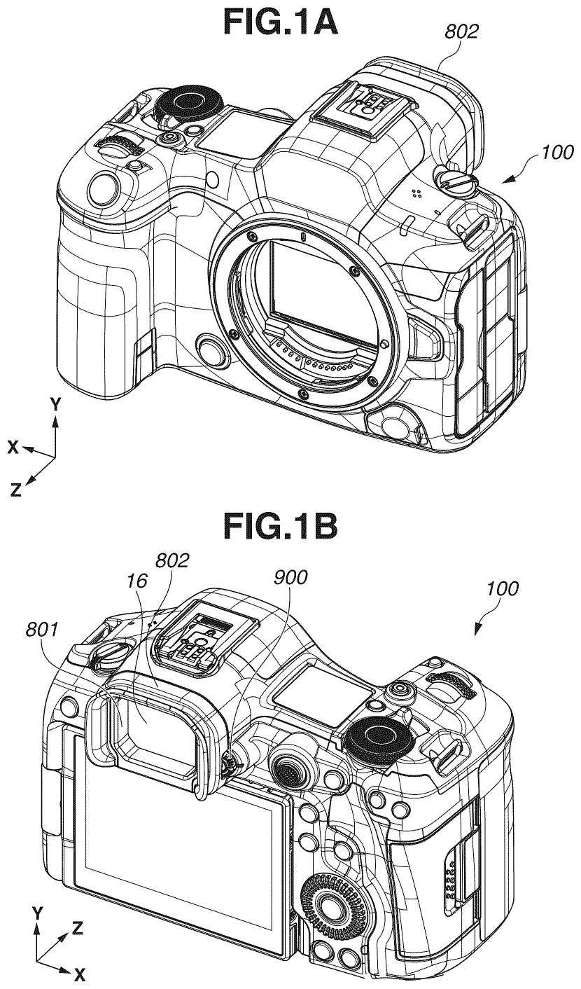

FIGS. 1A and 1B are external perspective views of a digital camera 100 as one example of the optical apparatuses to which the present disclosure is applicable.

A mobile phone, a game machine, a tablet terminal, a personal computer, a watch-type or an eyewear-type information terminal, and a head-mounted display are given as the examples of the optical apparatuses.

The present disclosure is also applicable to products having eyepiece units (e.g., a monocular viewer, a binocular viewer, and a range-finding meter), and eyepiece attachments attached to the eyepiece units (e.g., a rain cover, a magnifier, and an angle finder).

FIG. 1A illustrates an external perspective view from a front face of the digital camera 100. FIG. 1B illustrates an external perspective view from a back face of the digital camera 100.

In FIGS. 1A and 1B, a portion of an eyecup 802 which comes into contact with the user's eye is made of a soft material in order to prevent light from entering an interior of a viewfinder from a gap between an eyepiece frame 801 and the user's eye.

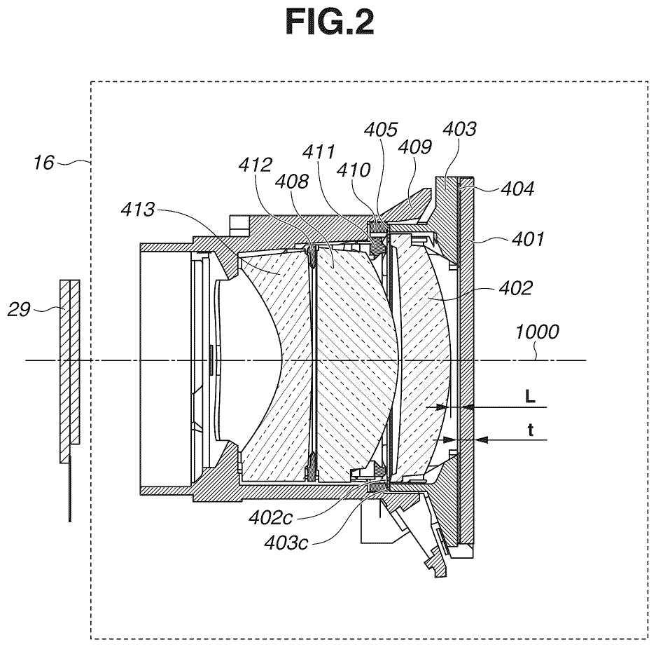

A position of an electronic viewfinder (EVF) module 29 (illustrated in FIG. 2) is adjusted by a diopter adjustment dial 900 based on the diopter of the user.

An eyepiece unit 16 is a magnifying optical system of an eyepiece viewfinder (i.e., look-into type viewfinder). The user can magnify and visually recognize, via the eyepiece unit 16, an image displayed on the EVF module 29 arranged inside.

The EVF module 29 is a display apparatus such as a liquid crystal display apparatus or an organic electroluminescence display apparatus, which displays an image based on an analog signal received from a digital-to-analog (D/A) conversion unit (not illustrated).

When the digital camera 100 is held at a normal position, a display of the EVF module 29 in a vertical direction is shorter than a display in a horizontal direction.

### (Configuration of Eyepiece Unit)

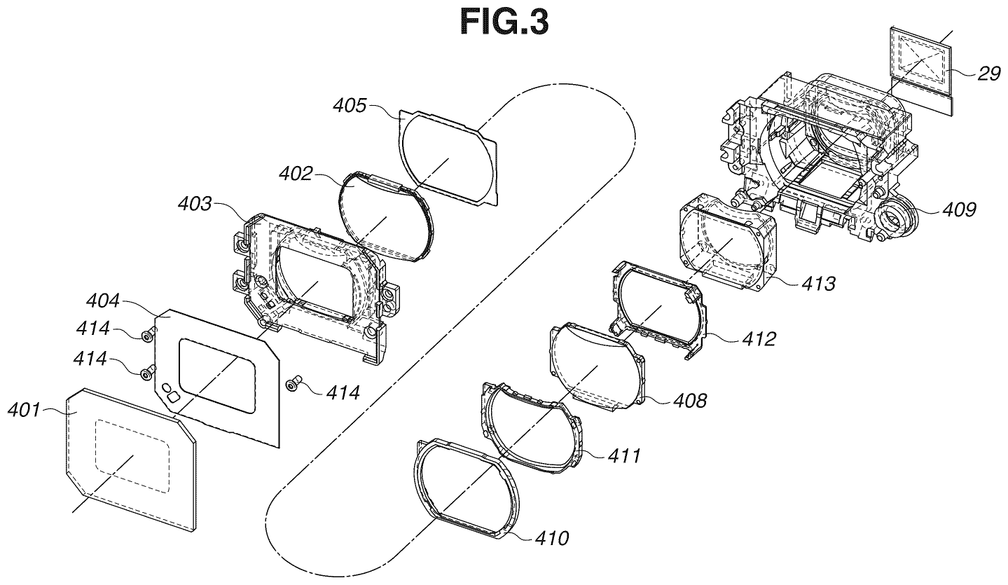

Next, a configuration of the eyepiece unit 16 as an optical apparatus according to the present exemplary embodiment will be described with reference to FIGS. 2 and 3.

FIG. 2 is a cross-sectional view of a configuration of the eyepiece unit 16.

FIG. 3 is an exploded perspective view of the eyepiece unit 16.

FIG. 2 illustrates a vertical cross-sectional view of the eyepiece unit 16 having an optical axis 1000 at a center, when the digital camera 100 (not illustrated) is held in a normal position. In FIG. 2, a left side is a side of the EVF module 29, and a right side is a side of an observer.

The eyepiece unit 16 is a magnifying optical system serving as a viewfinder mounted on a digital camera, a mirrorless camera, or a digital video camera, and that magnifies an image displayed on the EVF module 29 for the observer to observe. The eyepiece unit 16 is integrally or removably mounted on an image capturing apparatus.

Optical members 402, 408, and 413 are plastic lenses, and an optical member 401 is a flat plate-like cover window. The optical member 401 is made of plastic or glass.

The optical member 402 has a convex lens shape projecting to a side of the optical member 401.

Although the optical member 401 described in the present exemplary embodiment is a flat plate-like member, the optical member 401 may be a member having a lens shape.

In the present exemplary embodiment, because the optical member 402 projects to a side of the optical member 401 having a flat plate shape, the convex lens (i.e., optical member 402) enters a space between the optical members 401 and 402 when the space is sealed as described below. As a result, it is possible to reduce a volume.

Further, a distance between the optical members 401 and 402 in a vicinity of the optical axis 1000 can be reduced, so that a layer of air in the vicinity of the optical axis 1000 becomes thin. Consequently, a central portion of the optical member 401 through which the user looks into the digital camera 100 is less likely to be fogged when the digital camera 100 is used.

Further, because the optical member 401 which is in contact with the ambient air is a flat plate-like member, variation in temperatures is less likely to occur in the optical member 401. Therefore, the optical member 401 is uniformly less likely to be fogged.

A lens holding member 403 holds the optical members 401 and 402, and a lens holding member 409 holds the optical members 408 and 413.

A distance between the optical members 413, 408, and 402 is determined by spacers 411 and 412. The spacers 411 and 412 may also function as masks for preventing unnecessary light from entering the optical members 413, 408, and 402.

An elastic member 410 presses the optical members 413, 408, and 402 and the spacers 412 and 411 against the lens holding members 409 and 403. The elastic member 410 is formed of a material having elasticity, e.g., silicon rubber.

A sealing member 404 seals the optical member 401 and the lens holding member 403, so that the optical member 401 is held by the lens holding member 403. In the present exemplary embodiment, the sealing member 404 is a double-sided adhesive tape consisting of a polyolefin foamed base material on which an acrylic adhesive material is applied.

In a case where the optical member 401 is made of glass, the optical member 401 has resistance to an external force which causes deformation.

In this case, an ultraviolet (UV) curable adhesive agent or an anaerobic adhesive agent can be used as the sealing member 404 instead of the double-sided adhesive tape, as long as a gap between the lens holding member 403 and the optical member 401 can be sealed thereby.

Further, the sealing member 404 may also function as a mask for preventing unnecessary light from entering the optical members 402 and 401.

A sealing member 405 is a sheet-like sealing member for sealing the optical member 402 and the lens holding member 403.

According to the present exemplary embodiment, the sealing member 405 can be a one-sided adhesive tape or a double-sided adhesive tape consisting of a polyolefin foamed base material on which an acrylic adhesive material is applied, or can be a non-adhesive elastic sheet made of a material such as silicon rubber.

Further, the sealing member 405 may also function as a mask for preventing unnecessary light from entering the optical members 402 and 408. Further, the effect of the sealing members 404 and 405 can be improved by using a material such as a polyethylene film having low moisture permeability as the base materials.

The EVF module 29 can be moved in a direction parallel to the optical axis 1000 by rotating the diopter adjustment dial 900 (illustrated in FIG. 1B) through a cam mechanism (not illustrated).

In this way, the user can adjust a position of the EVF module 29 based on the diopter of the user.

In the present exemplary embodiment, the EVF module 29 is moved by the diopter adjustment dial 900. Therefore, even when the user adjusts the diopter, relative positions of the optical members 401 and 402 are not changed.

In accordance with the display of the EVF module 29, an optical effective range in the up-down direction of each of the optical members 401, 402, 408, and 412 is shorter than an optical effective range in the right-left direction when the digital camera 100 is held at a normal position.

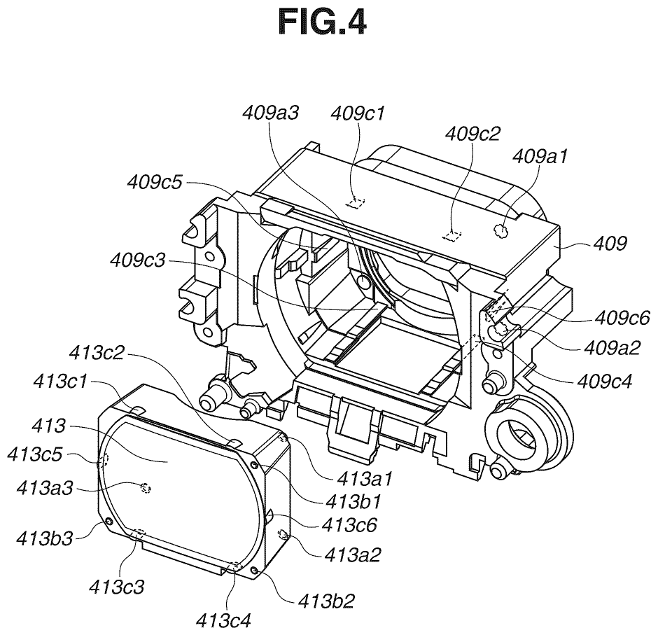

Next, with reference to FIGS. 4 to 12, a configuration of the eyepiece unit 16 is described in detail according to the assembly order.

### (Exploded Perspective View of a State Before Optical Member 413 is Mounted on Lens Holding Member 409)

FIG. 4 is an exploded perspective view of a state before the optical member 413 is mounted on the lens holding member 409.

A position of the optical member 413 in a radial direction with respect to the optical axis 1000 (illustrated in FIG. 2) of the lens is determined by radial bearing faces 413c1 to 413c6 provided on an outer circumference of the optical member 413.

The radial bearing faces 413cl to 413c6 respectively abut on radial bearing faces 409c1 to 409c6 provided on an inner circumference of the lens holding member 409, so that a position of the optical member 413 in the radial direction, at which the optical axis of the optical member 413 coincides with the optical axis 1000 of the eyepiece unit 16, is determined.

A position of the optical member 413 in a thrust direction with respect to the optical axis 1000 of the eyepiece unit 16 is determined by thrust bearing faces 413al to 413a3 and 413b1 to 413b3.

The above-described thrust bearing faces 413al to 413a3 and 413b1 to 413b3 are provided on the outer circumferential portion of the optical member 413, on the outer side of the optical effective range of the optical member 413. The thrust bearing faces 413a1 to 413a3 and 413b1 to 413b3 are respectively provided at three points on the front side and three points on the back side of the optical member 413, and positions thereof on the front side and positions thereof on the back side are substantially the same on a projection face viewed in the optical axis direction.

The optical member 413 is held by making only the thrust bearing faces 413al to 413a3 and 413b1 to 413b3 contact with the lens holding member 409. With this configuration, bending stress is less likely to be placed on the optical member 413, so that degradation of optical performance caused by deformation is less likely to occur.

The thrust bearing faces 413al to 413a3 respectively abut on thrust bearing faces 409a1 to 409a3 provided on the lens holding member 409, so that the position of the optical member 413 in the thrust direction is determined.

### (Exploded Perspective View of a State Before Spacer 412 is Mounted on Lens Holding Member 409)

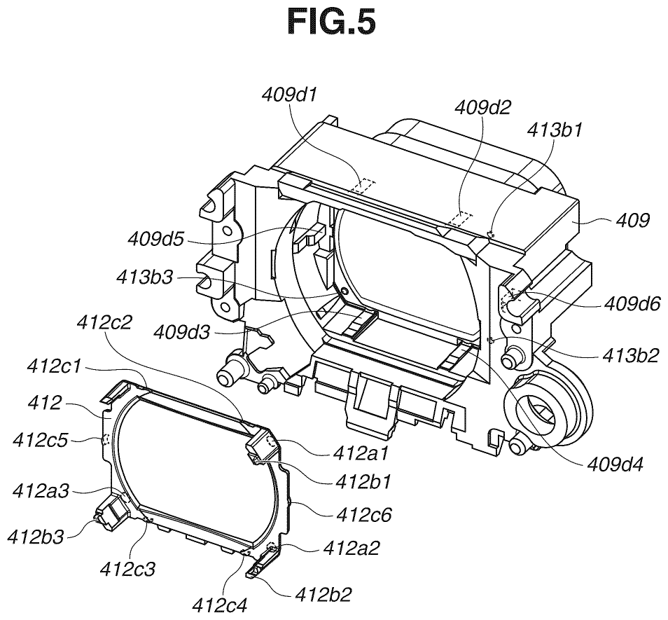

FIG. 5 is an exploded perspective view of a state before the spacer 412 is mounted on the lens holding member 409 after the optical member 413 is mounted thereon.

A position of the spacer 412 in the radial direction with respect to the optical axis 1000 (illustrated in FIG. 2) of the lenses is determined by radial bearing faces 412c1 to 412c6 provided on an outer circumference of the spacer 412.

The radial bearing faces 412cl to 412c6 respectively abut on radial bearing faces 409d1 to 409d6 provided on an inner circumference of the lens holding member 409, so that a position of the spacer 412 in the radial direction, at which the optical axis of the spacer 412 coincides with the optical axis 1000 of the eyepiece unit 16, is determined.

A position of the spacer 412 in the thrust direction with respect to the optical axis 1000 of the eyepiece unit 16 is determined by thrust bearing faces 412al to 412a3 and 412b1 to 412b3.

The thrust bearing faces 412al to 412a3 and 412b1 to 412b3 are respectively arranged at three points on the front side and three points on the back side of the spacer 412, and positions thereof on the front side and positions thereof on the back side are substantially the same on a projection face viewed in the optical axis direction.

Because the spacer 412 is held by making only the thrust bearing faces 412al to 412a3 and 412b1 to 412b3 contact with the lens holding member 409, bending stress is less likely to be placed on the spacer 412.

With this configuration, positional accuracy of the thrust bearing faces 412al to 412a3 and 412b1 to 412b3 is less likely to be degraded.

The thrust bearing faces 412al to 412a3 respectively abut on the thrust bearing faces 413b1 to 413b3 provided on the optical member 413, so that a position of the spacer 412 in the thrust direction is determined.

### (Exploded Perspective View of a State Before Optical Member 408 is Mounted on Lens Holding Member 409)

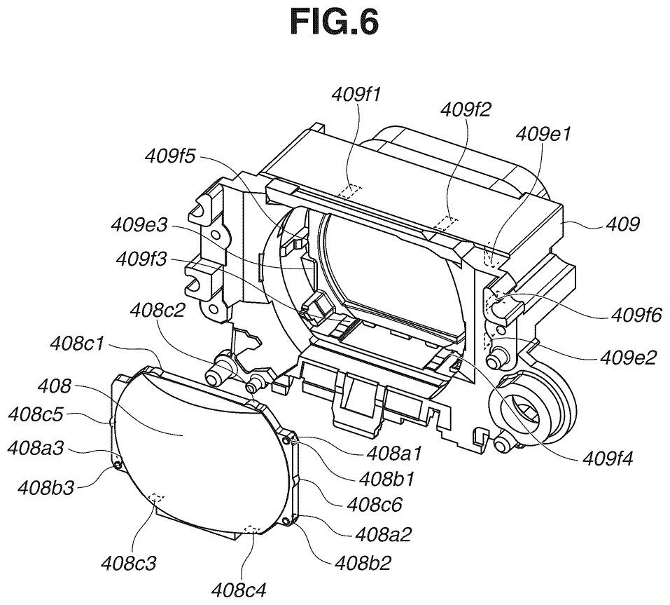

FIG. 6 is an exploded perspective view of a state before the optical member 408 is mounted on the lens holding member 409 after the optical member 413 and the spacer 412 are mounted thereon.

A position of the optical member 408 in the radial direction with respect to the optical axis 1000 (illustrated in FIG. 2) of the lens is determined by radial bearing faces 408c1 to 408c6 provided on an outer circumference of the optical member 408.

The radial bearing faces 408c1 to 408c6 respectively abut on radial bearing faces 409f1 to 409f6 provided on an inner circumference of the lens holding member 409, so that a position of the optical member 408 in the radial direction, at which the optical axis of the optical member 408 coincides with the optical axis 1000 of the eyepiece unit 16, is determined.

A position of the optical member 408 in the thrust direction with respect to the optical axis 1000 of the eyepiece unit 16 is determined by thrust bearing faces 408al to 408a3 and 408b1 to 408b3.

The above-described thrust bearing faces 408al to 408a3 and 408b1 to 408b3 are provided on the outer circumferential portion of the optical member 408, on the outer side of the optical effective range of the optical member 408. The thrust bearing faces 408a1 to 408a3 and 408b1 to 408b3 are respectively provided at three points on the front side and three points on the back side of the optical member 408, and positions thereof on the front side and positions thereof on the back side are substantially the same on a projection face viewed in the optical axis direction.

The optical member 408 is held by making only the thrust bearing faces 408a1 to 408a3 and 408b1 to 408b3 contact with the lens holding member 409. With this configuration, bending stress is less likely to be placed on the optical member 408, so that degradation of optical performance caused by deformation is less likely to occur.

The thrust bearing faces 408al to 408a3 respectively abut on thrust bearing faces 409e1 to 409e3 provided on the lens holding member 409, so that a position of the optical member 408 in the thrust direction is determined.

As described above, the optical members 413 and 408 are respectively in contact with and held by the lens holding member 409 at different positions.

With this configuration, in a case where inclination occurs in the optical members 413 and 408 depending on a dimension of a finished component, each of the optical members 413 and 408 can individually be corrected by modifying the heights of the thrust bearing faces at three positions.

### (Exploded Perspective View of a State Before Spacer 411 is Mounted on Lens Holding Member 409)

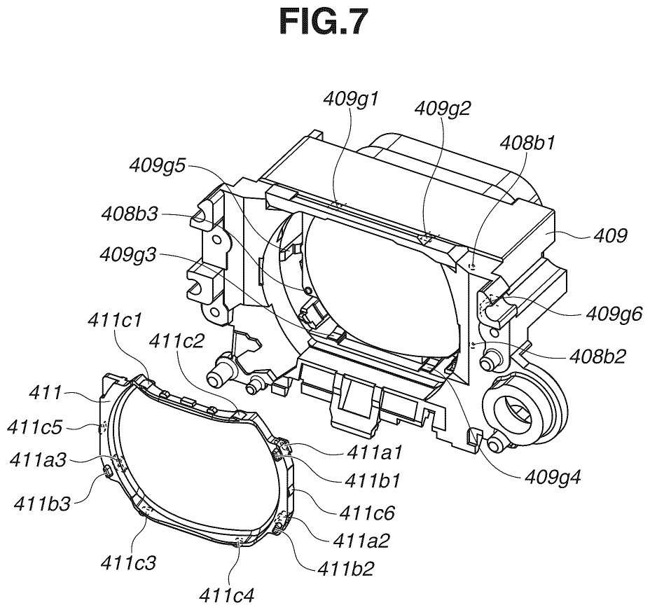

FIG. 7 is an exploded perspective view of a state before the spacer 411 is mounted on the lens holding member 409 after the optical member 413, the spacer 412, and the optical member 408 are mounted thereon.

A position of the spacer 411 in the radial direction with respect to the optical axis 1000 (illustrated in FIG. 2) of the lenses is determined by radial bearing faces 411c1 to 411c6 provided on an outer circumference of the spacer 411.

The radial bearing faces 411c1 to 411c6 respectively abut on radial bearing faces 409g1 to 409g6 provided on an inner circumference of the lens holding member 409, so that a position of the spacer 411 in the radial direction, at which the optical axis of the spacer 411 coincides with the optical axis 1000 of the eyepiece unit 16, is determined.

A position of the spacer 411 in the thrust direction with respect to the optical axis 1000 of the eyepiece unit 16 is determined by thrust bearing faces 411al to 411a3 and 411b1 to 411b3.

The thrust bearing faces 411al to 411a3 and 411b1 to 411b3 are respectively provided at three points on the front side and three points on the back side of the spacer 411, and positions thereof on the front side and positions thereof on the back side are substantially the same on a projection face viewed in the optical axis direction.

Because the spacer 411 is held by making only the thrust bearing faces 411al to 411a3 and 411b1 to 411b3 contact with the lens holding member 409, bending stress is less likely to be placed on the spacer 411.

With this configuration, positional accuracy of the thrust bearing faces 411al to 411a3 and 411b1 to 411b3 is less likely to be degraded.

The thrust bearing faces 411al to 411a3 respectively abut on the thrust bearing faces 408b1 to 408b3 provided on the optical member 408, so that a position of the spacer 411 in the thrust direction is determined.

### (Exploded Perspective View of a State Before Elastic Member 410 is Mounted on Lens Holding Member 409)

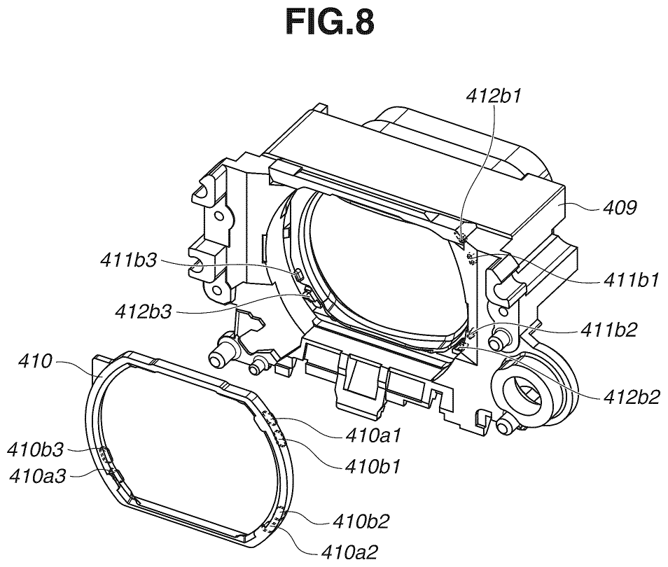

FIG. 8 is an exploded perspective view of a state before an elastic member 410 is mounted on the lens holding member 409 after the optical member 413, the spacer 412, the optical member 408, and the spacer 411 are mounted thereon.

Thrust bearing faces 410al to 410a3 and 410b1 to 410b3 are provided on the elastic member 410.

The thrust bearing faces 410al to 410a3 respectively abut on the thrust bearing faces 412b1 to 412b3 provided on the spacer 412, and the thrust bearing faces 410b1 to 410b3 respectively abut on the thrust bearing faces 411b1 to 411b3 provided on the spacer 411.

Further, as described below, the sealing member 405 abuts on the elastic member 410 to compress the elastic member 410.

Therefore, elastic force is generated to cause the optical member 413 to be urged against the lens holding member 409 via the spacer 412, and to cause the optical member 408 to be urged against the lens holding member 409 via the spacer 411.

Then, the optical member 402 is urged against the lens holding member 403 via the sealing member 405, so that the thrust positions of the optical members 413 and 408 are stabilized.

(Exploded Perspective View of a State Before Optical Member 401 is Fixed with Sealing Member 404)

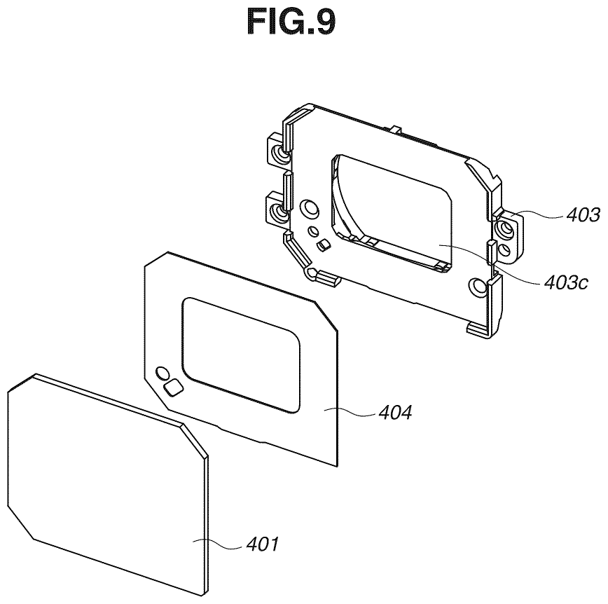

FIG. 9 is an exploded perspective view of a state before the optical member 401 is fixed to the lens holding member 403 by the sealing member 404.

The sealing member 404 is a double-sided adhesive tape with adhesive materials applied on both sides. The sealing member 404 is held between the lens holding member 403 and the optical member 401 to seal a gap between an opening portion 403d of the lens holding member 403 and the optical member 401. In the present exemplary embodiment, a double-sided adhesive tape is used as the sealing member 404.

However, in a case where the optical member 401 is a lens made of glass, image distortion caused by shrinkage of an adhesive agent does not occur because optical performance thereof is not affected by shrinkage of the adhesive agent. Therefore, in this case, the gap may be sealed by applying the adhesive agent to the entire circumference of the optical member 401.

### (Exploded Perspective View of a State Before Optical Member 402 is Mounted on Lens Holding Member 403)

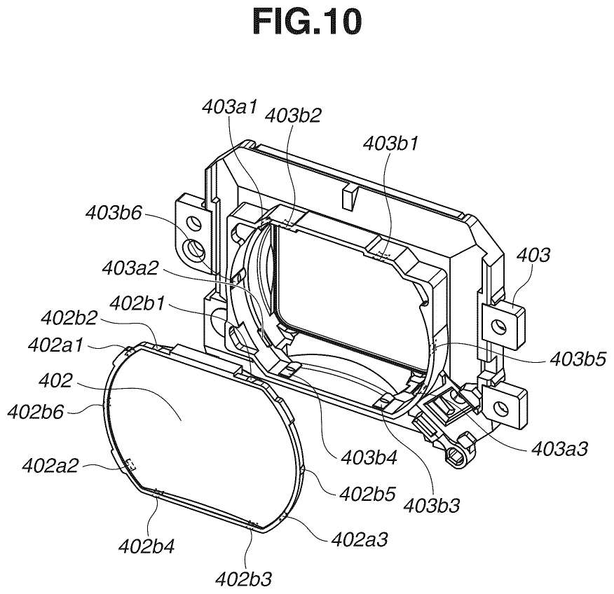

FIG. 10 is an exploded perspective view of a state before the optical member 402 is mounted on the lens holding member 403 after the optical member 401 is sealed and fixed to the lens holding member 403.

A position of the optical member 402 in the radial direction with respect to the optical axis 1000 (illustrated in FIG. 2) of the lenses is determined by radial bearing faces 402b1 to 402b6 provided on an outer circumference of the optical member 402.

The radial bearing faces 402b1 to 402b6 respectively abut on radial bearing faces 403b1 to 403b6 provided on an inner circumference of the lens holding member 403, so that a position of the optical member 402 in the radial direction, at which the optical axis of the optical member 402 coincides with the optical axis 1000 of the eyepiece unit 16, is determined.

A position of the optical member 402 in the thrust direction with respect to the optical axis 1000 of the eyepiece unit 16 is determined by thrust bearing faces 402al to 402a3.

The thrust bearing faces 402al to 402a3 respectively abut on thrust bearing faces 403a1 to 403a3 provided on the lens holding member 403, so that a position of the optical member 402 in the thrust direction is determined.

(Exploded Perspective View of a State Before Gap is Sealed with Sealing Member 405)

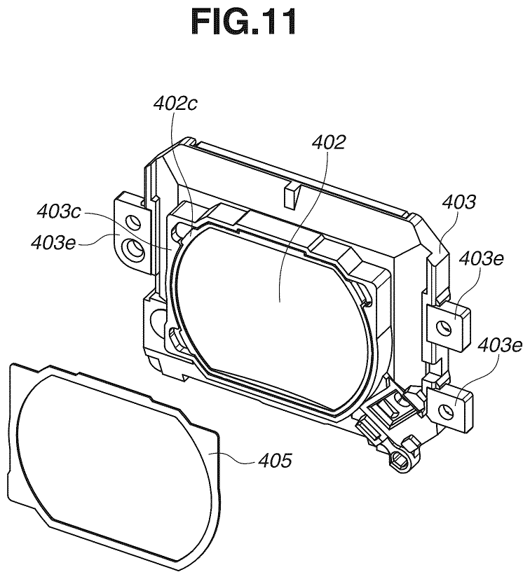

FIG. 11 is an exploded perspective view of a state before a gap between the lens holding member 403 and the optical member 402 is sealed with the sheet-like sealing member 405.

A planar face portion 402c vertical to the optical axis 1000 is provided on the optical member 402 on the outer circumference portion, on the outer side of the optical effective range of the optical member 402.

Further, a planar face portion 403c vertical to the optical axis 1000 is provided on the lens holding member 403, at a portion which is to be located on the outer circumference portion of the optical member 402 when the optical member 402 is mounted on the lens holding member 403.

When the optical member 402 is mounted on the lens holding member 403, the above-described two planar face portions 402c and 403c have substantially the same heights.

An adhesive agent is applied to one of the surfaces of the sealing member 405 facing the optical member 402.

The sealing member 405 is applied to both of the planar face portion 403c of the lens holding member 403 and the planar face portion 402c of the optical member 402 having substantially the same heights without any gap, so that the lens holding member 403 and the optical member 402 are sealed.

Through the above-described configuration, it is possible to seal the plastic optical member 402 susceptible to deformation by an external force without placing a load that may cause deformation.

As described above, only the optical member 401, which is in contact with the ambient air, and the second-outermost optical member 402 are mounted on the lens holding member 403 different from the lens holding member 409.

In this way, when the optical member 402 is mounted on the lens holding member 403, the sheet-like sealing member 405 can easily be applied to the planar face portions 402c and 403c having substantially the same heights.

(Exploded Perspective View of a State Before Lens Holding Member 403 is Combined with Lens Holding Member 409 after Optical Members 401 and 402 are Sealed and Fixed to the Lens Holding Member 403)

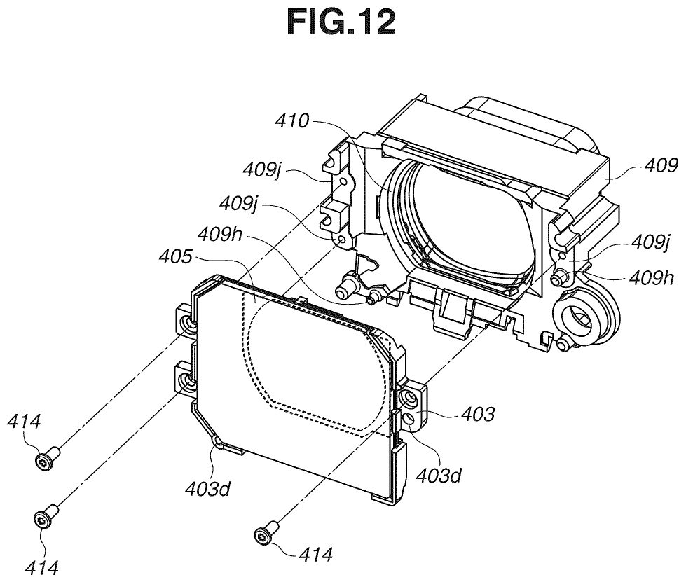

FIG. 12 is an exploded perspective view of a state before the lens holding member 403, on which the optical members 401 and 402 are sealed and fixed, is combined with the lens holding member 409, on which the optical member 413, the spacer 412, the optical member 408, the spacer 411, and the elastic member 410 are mounted.

Positioning pins 409h provided on the lens holding member 409 fit into positioning holes 403d provided in the lens holding member 403, so that a position of the lens holding member 403 in the radial direction is determined.

Further, planar face portions 403e (illustrated in FIG. 11) of the lens holding member 403 respectively abut on planar face portions 409j of the lens holding member 409, so that a position of the lens holding member 403 in the thrust direction is determined. Then, the two lens holding members 409 and 403 are fixed with screws 414.

At this time, the sealing member 405 abuts on the elastic member 410 to compress the elastic member 410, so that elastic force is generated.

As a result, the optical member 413 is urged against the lens holding member 409 via the spacer 412, and the optical member 408 is urged against the lens holding member 409 via the spacer 411.

The optical member 402 is urged against the lens holding member 403 via the sealing member 405, so that the positions of the optical members 413 and 408 in the thrust direction are stabilized.

Further, because the sealing member 405 is urged against both of the optical member 402 and the lens holding member 403 by the elastic member 410, the optical member 402 and the lens holding member 403 are sealed more tightly.

In the present exemplary embodiment, the optical members 413 and 408 are urged against the lens holding member 403 by the elastic member 410 via the spacers 411 and 412. However, the optical members 413 and 408 may be urged against the lens holding member 403 by the elastic member 410 which is directly in contact with the optical member 413 or 408.

Through the above-described configuration, a space between the optical members 401 and 402 is sealed with the sealing member 404, the lens holding member 403, and the sheet-like sealing member 405. With this configuration, it is possible to prevent entry of moisture from the outside.

Accordingly, a humidity is less likely to be high on an inner face side of the optical member 401, so that an amount of moisture in a sealed space is less likely to exceed the saturated moisture amount even when a temperature on the inner face side of the optical member 401 is decreased due to the influence of the ambient air. Therefore, it is possible to prevent the optical member 401 from being fogged easily.

Further, only the space between the optical members 401 and 402 is sealed.

With this configuration, an absolute amount of moisture present in the sealed space can be reduced.

Therefore, even if the temperature on the inner face side of the optical member 401 decreases due to the influenced of the ambient air, and the amount of moisture in the sealed space exceeds the saturated moisture amount, it is possible to suppress fogging to a minimum extent.

Further, because the optical member 402 projects to a side of the optical member 401 having a flat plate shape, the convex lens (i.e., optical member 402) enters a space between the optical members 401 and 402 when the space is sealed. Therefore, it is possible to reduce the volume.

Further, a distance L (illustrated in FIG. 2) between the optical members 401 and 402 in a vicinity of the optical axis 1000 is made shorter than a thickness t (illustrated in FIG. 2) of the optical member 401, so that a layer of air in the vicinity of the optical axis 1000 becomes thin. Consequently, a central portion of the optical member 401 through which the user looks into the digital camera 100 is less likely to be fogged when the digital camera 100 is used.

Further, the optical member 401 which is in contact with the ambient air is a flat plate-like member. With this configuration, variation in temperatures is less likely to occur in the optical member 401, so that the optical member 401 is uniformly less likely to be fogged.

Further, even when at least either one of the optical member 401 in contact with the ambient air and the second-outermost optical member 402 is made of a plastic material, the space can be sealed with the sheet-like sealing member 405 without placing a load on the lenses (i.e., optical members 401 and 402).

Therefore, it is possible to prevent dew condensation without causing worsening of surface accuracy, degradation of resolution, and distortion of an image.

The characteristics of the present exemplary embodiment will be described below in an organized manner.

The first characteristic will be described with reference to FIG. 2.

The optical apparatus includes a first optical member 401 in contact with ambient air and a second optical member 402 located on an inner side of the first optical member 401 from among an optical system including at least two optical members.

The optical apparatus further includes a first holding member 403 capable of holding the first optical member 401 and the second optical member 402 and a first sealing member 404 for sealing a gap between the first optical member 401 and the first holding member 403.

The optical apparatus further includes a second sealing member 405 for sealing a gap between the first holding member 403 and the second optical member 402.

The second optical member 402 has an abutting portion 402c on an outer circumferential portion, at which the second sealing member 405 is in contact with the second optical member 402, and the first holding member 403 has an abutting portion 403c on an outer circumferential portion, at which the second sealing member 405 is in close contact with the first holding member 403.

The first optical member 401 and the first holding member 403 are sealed with the first sealing member 404, and a space between the first optical member 401 and the second optical member 402 is sealed.

The second characteristic will be described with reference to FIGS. 2 and 3.

The first optical member 401 is a flat plate.

The third characteristic will be described with reference to FIGS. 2 and 3.

The second optical member 402 is made of plastic.

The fourth characteristic will be described with reference to FIG. 2.

The second optical member 402 is a convex shape lens convexed toward the first optical member 401.

The fifth characteristic will be described with reference to FIG. 2.

A distance between the first optical member 401 and the second optical member 402 on an optical axis is shorter than a thickness of the first optical member 401.

The sixth characteristic will be described with reference to FIG. 2.

The first sealing member 404 is a double-sided adhesive tape.

The seventh characteristic will be described with reference to FIG. 2.

The first sealing member 404 is an adhesive agent.

The eighth characteristic will be described with reference to FIGS. 2 and 9.

Either one of the first sealing member 404 and the second sealing member 405 also functions as a mask for limiting an optical path.

The ninth characteristic will be described with reference to FIG. 3.

The optical apparatus further includes an electronic display apparatus 29, and the first optical member 401 and the second optical member 402 constitute a magnifying optical system through which the electronic display apparatus 29 is magnified and observed.

The tenth characteristic will be described with reference to FIG. 2.

An optical effective range of each of the first optical member 401 and the second optical member 402 is shorter in a vertical direction than in a horizontal direction.

The eleventh characteristic will be described with reference to FIGS. 1A and 1B.

The optical apparatus further includes a diopter adjustment unit 900 for adjusting diopter of the electronic display apparatus 29, wherein the diopter can be adjusted by the diopter adjustment unit 900 by moving a position of the electronic display apparatus 29 in an optical axis direction.

The twelfth characteristic will be described with reference to FIGS. 1A and 1B.

A relative positional relationship between the first optical member 401 and the second optical member 402 does not change when the diopter is adjusted by the diopter adjustment unit 900.

The thirteenth characteristic will be described with reference to FIG. 2.

The optical apparatus further includes a third optical member 408 arranged on an inner side of the second optical member 402, a second holding member 409 for holding the third optical member 408, and an urging member 410 for urging the first holding member 403 against the second holding member 409.

The second sealing member 405 is in contact with the urging member 410 to compress the urging member 410, thereby urging the first holding member 403 against the second holding member 409 and determining a position in the optical axis direction.

The fourteenth characteristic will be described with reference to FIG. 2.

The abutting portion of the second optical member 402 is a planar face portion 402c at which the second sealing member 405 is in close contact with the second optical member 402.

The abutting portion of the first holding member 403 is a planar face portion 403c at which the second sealing member 405 is in close contact with the first holding member 403.

Next, combinations of the exemplary embodiments included in the present disclosure will be described.

### (Configuration 1)

An optical apparatus includes a first optical member 401 and a second optical member 402 located on an inner side of the first optical member 401 from among an optical system including at least two optical members, a first holding member 403 configured to hold the first optical member 401 and the second optical member 402, a first sealing member 404 for sealing a gap between the first optical member 401 and the first holding member 403, and a second sealing member 405 for sealing a gap between the first holding member 403 and the second optical member 402, wherein the second optical member 402 has an abutting portion 402c on an outer circumferential portion, at which the second sealing member 405 is in close contact with the second optical member 402, wherein the first holding member 403 has an abutting portion 403c on an outer circumferential portion, at which the second sealing member 405 is in close contact with the first holding member 403, wherein the first optical member 401 and the first holding member 403 are sealed with the first sealing member 404, and wherein a space between the first optical member 401 and the second optical member 402 is sealed.

### (Configuration 2)

The optical apparatus according to Configuration 1, wherein the first optical member 401 is a flat plate.

### (Configuration 3)

The optical apparatus according to Configuration 1 or 2, wherein the second optical member 402 is made of plastic.

### (Configuration 4)

The optical apparatus according to any one of Configurations 1 to 3, wherein the second optical member 402 is a convex shape lens convexed toward the first optical member 401.

### (Configuration 5)

The optical apparatus according to any one of Configurations 2 to 4, wherein a distance between the first optical member 401 and the second optical member 402 on an optical axis is shorter than a thickness of the first optical member 401.

### (Configuration 6)

The optical apparatus according to any one of Configurations 1 to 5, wherein the first sealing member 404 is a double-sided adhesive tape.

### (Configuration 7)

The optical apparatus according to any one of Configurations 1 to 6, wherein the first sealing member 404 is an adhesive agent.

### (Configuration 8)

The optical apparatus according to any one of Configurations 1 to 7, wherein either one of the first sealing member 404 and the second sealing member 405 also functions as a mask for limiting an optical path.

### (Configuration 9)

The optical apparatus according to any one of Configurations 1 to 8, further includes an electronic display apparatus 29, wherein the first optical member 401 and the second optical member 402 constitute a magnifying optical system through which the electronic display apparatus 29 is magnified and observed.

### (Configuration 10)

The optical apparatus according to any one of Configurations 1 to 9, wherein an optical effective range of each of the first optical member 401 and the second optical member 402 is shorter in a vertical direction than in a horizontal direction.

### (Configuration 11)

The optical apparatus according to Configuration 9, further includes a diopter adjustment unit 900 for adjusting diopter of the electronic display apparatus 29, wherein the diopter can be adjusted by the diopter adjustment unit 900 by moving a position of the electronic display apparatus 29 in the optical axis direction.

### (Configuration 12)

The optical apparatus according to Configuration 11, wherein a relative positional relationship between the first optical member 401 and the second optical member 402 does not change when the diopter is adjusted by the diopter adjustment unit 900.

### (Configuration 13)

The optical apparatus according to any one of Configurations 1 to 12, further includes a third optical member 408 arranged on an inner side of the second optical member 402, a second holding member 409 for holding the third optical member 408, and an urging member 410 for urging the first holding member 403 against the second holding member 409, wherein the second sealing member 405 is in contact with the urging member 410 to compress the urging member 410, thereby urging the first holding member 403 against the second holding member 409 and determining a position in the optical axis direction.

### (Configuration 14)

The optical apparatus according to any one of Configurations 1 to 13, wherein the abutting portion of the second optical member 402 is a planar face portion 402c at which the second sealing member 405 is in close contact with the second optical member 402, and wherein the abutting portion of the first holding member 403 is a planar face portion 403c at which the second sealing member 405 is in close contact with the first holding member 403.

Although the exemplary embodiments of the present disclosure have been described as the above, the invention is not limited to these exemplary embodiments, and many variations and modifications are possible.

Through the configuration according to the above-described exemplary embodiments, even when either one of the eyepiece lens contact with ambient air and the second-outermost eyepiece lens is made of a plastic material, worsening of surface accuracy, degradation of resolution, and distortion of an image can be reduced.

Further, through the configuration according to the above-described exemplary embodiments, dew condensation caused by entry of moisture into the inner side of the eyepiece lens can also be suppressed.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-026140, filed Feb. 26, 2024, which is hereby incorporated by reference herein in its entirety.

What is claimed is:

1. An optical apparatus comprising:
a first optical member and a second optical member located on an inner side of the first optical member;
a first holding member configured to hold the first optical member and the second optical member;
a first sealing member configured to seal a gap between the first optical member and the first holding member; and
a second sealing member configured to seal a gap between the first holding member and the second optical member,
wherein the second optical member has an abutting portion on an outer circumferential portion, at which the second sealing member is in contact with the second optical member,
wherein the first holding member has an abutting portion on an outer circumferential portion, at which the second sealing member is in contact with the first holding member,
wherein the first optical member and the first holding member are sealed with the first sealing member, and
wherein a space between the first optical member and the second optical member is sealed.

2. The optical apparatus according to claim 1, wherein the first optical member is a flat plate.

3. The optical apparatus according to claim 2, wherein a distance between the first optical member and the second optical member on an optical axis is shorter than a thickness of the first optical member.

4. The optical apparatus according to claim 1, wherein the second optical member is made of plastic.

5. The optical apparatus according to claim 1, wherein the second optical member is a convex shape lens convexed toward the first optical member.

6. The optical apparatus according to claim 1, wherein the first sealing member is a double-sided adhesive tape.

7. The optical apparatus according to claim 1, wherein the first sealing member is an adhesive agent.

8. The optical apparatus according to claim 1, wherein either one of the first sealing member and the second sealing member limits an optical path.

9. The optical apparatus according to claim 1, further comprising an electronic display apparatus,
wherein the first optical member and the second optical member constitute a magnifying optical system through which the electronic display apparatus is magnified and observed.

10. The optical apparatus according to claim 9, further comprising a diopter adjustment unit configured to adjust diopter of the electronic display apparatus,
wherein the diopter can be adjusted by the diopter adjustment unit by moving a position of the electronic display apparatus in an optical axis direction.

11. The optical apparatus according to claim 10, wherein a relative positional relationship between the first optical member and the second optical member does not change when the diopter is adjusted by the diopter adjustment unit.

12. The optical apparatus according to claim 1, wherein an optical effective range of each of the first optical member and the second optical member is shorter in a vertical direction than in a horizontal direction.

13. The optical apparatus according to claim 1, further comprising:
a third optical member arranged on an inner side of the second optical member;
a second holding member configured to hold the third optical member; and
an urging member configured to urge the first holding member against the second holding member,
wherein the second sealing member is in contact with the urging member to compress the urging member, thereby urging the first holding member against the second holding member and determining a position in the optical axis direction.

14. The optical apparatus according to claim 1,
wherein the abutting portion of the second optical member is a planar face portion at which the second sealing member is in close contact with the second optical member, and
wherein the abutting portion of the first holding member is a planar face portion at which the second sealing member is in close contact with the first holding member.
